(19) United States
(12) Patent Application Publication
(10) Pub. No.: US 2005/0087989 A1
(43) Pub. Date: Apr. 28, 2005

(54) Apparatus and process for generating electric power by utilizing high frequency high voltage oscillating current as a carrier for high EMF DC in an armature board

(76) Inventor: Robert Holcomb, Nashville, TN (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002, US

(21) Appl. No.: 10/694,326

(22) Filed: Oct. 27, 2003

(51) Int. Cl. H02P 9/04

(52) U.S. Cl. 290/1 R

(57) ABSTRACT

A system for generating electric power by utilizing high frequency high voltage oscillating current as a carrier for high EMF DC in an armature board wherein a large elliptical conductor coil, which is wound concurrent with and parallel to 2 exciter coils, which are wound in opposite directions to each other. The coils are placed on or in support means in close proximity over rows of a North pole face charged magnetic bodies in the superior portion of the coils and “S” South poles aligned underneath the inferior portion of the coils so that the current is generated by exciting the exciter coil through slip ring connections in which half of the ring closes the circuit and half of the ring opens the circuit.

### CROSS-REFERENCE TO RELATED APPLICATIONS

Priority of U.S. Provisional Patent Application, entitled “Apparatus and Process For Generating Electric Power by Utilizing High Frequency High Voltage Oscillating Current as a carrier for high EMF DC in an Armature Board Composed of Laminated Steel and Wound with Exciter Circuits in Proximity to a Stator Board of Laminated Steel Wound with a Collector Coil and Separated by an Air Gap and Aluminum Screen Wire to Contain the High Frequency Within the Armature Board,” filed Oct. 25, 2002, bearing Ser. No. 60/421,097, incorporated herein by reference, is hereby claimed.

The following applications are also related and are incorporated by reference herein:
“Apparatus and Process for Converting The Force of Gravity Combined with Magnetic Levitation To Usable Mechanical and/or Electrical Energy,” filed Feb. 23, 2001;
“Apparatus and Process for Converting the Formula and Operating of the Windings in Power Generating Equipment and Electric Motors to an increased Efficiency, By Removing the Power Reaction Force or Drag and Decreasing the Resistance in the coils,” filed Jul. 4, 2001;
“Apparatus and Process for Generating Electric Power by Alternating Fields of High Frequency, High Voltage Across Static Magnetic Flux Fields and Collecting the Current on Collector/Conductor Coils Co-wound with the Exciter Coils,” filed Jul. 16, 2001; and
“Apparatus and Process for Generating Electric Power by Alternating Fields of High Frequency and High Voltage Which Generate Pulsating Fields Which In Turn Push Electrons Across Static Magnetic Flux Fields of the Invention and Collecting the Current on Collector/Conductor Coils Co-wound with the Exciter Coils,” filed Jan. 24, 2002.

### STATEMENT REGARDING FEDERALLY SPONSORED RESEARCH OR DEVELOPMENT

Not applicable.

### REFERENCE TO A “MICROFICHE APPENDIX”

Not applicable.

### BACKGROUND OF THE INVENTION

1. Technical Field of the Invention

This stage of the invention represents the last stage of what is also referred to as the Holcomb Energy Cell (HEC™) which allows a powerful EMF (electromotive force) to be generated by taking the high voltage, high frequency and high amperage power generated by the previous stages which are depicted in the above provisional patents and earlier in this application and feeding this power into the exciter coils of the armature board which faces the stator or power board. The high voltage high frequency, high amperage current is fed into the exciter coils from a slip ring about 5→10 degrees leading input of low voltage, high amperage DC current. The high voltage, high frequency, high amperage current pushes free electrons or electrons at large as well as weakly bound electrons of the wire out to the peripheral surface of the wire such that it functions as a super conductor when subsequent DC current is fed in over the high frequency high voltage and high amperage current. The high frequency AC circuit is broken simultaneous with the DC current. The MMF (magneto-motive force) collapses as the circuit is broken, it then pushes electrons out along the coils at a high EMF. This pulsating DC current is fed back into the battery power supply. Therefore the exciter board generates large amounts of power, which is collected during the half cycle in which the exciter currents are off. Concurrent with this power generation the stator board is creating pulsed DC current. This current is used as DC or pulsed into a transformer at 60 cycles/sec and converted to 60 cycles AC.

The method and apparatus of the present invention relates to the conversion of energy from electrons “at large” (free electrons) to electrical and ultimately mechanical energy by exciting and the harnessing the free electrons. More particularly the present invention relates to a large elliptical conductor coil, which is wound concurrent with and parallel to 2 exciter coils, which are wound in opposite directions to each other. The coils are placed on or in support means in close proximity over closely spaced rows of “N” North pole face charged magnetic bodies in the superior portion of the coils and “S” South poles aligned underneath the inferior portion of the coils. The exciter coils (which serve the same function as the armature on a classic generator) are wound within sets of coils which each generate a separate phase of power when properly converted. The current (flowing electrons) is generated by exciting the exciter coil through slip ring connections in which half of the ring closes the circuit and half of the ring opens the circuit. An alternate embodiment of this circuit breaker system is through the use of oscillating vacuum switches, which may be driven by solenoids. The current, which is fed onto the exciter coils, is high frequency (Kilo Hertz®Mega Hertz) high voltage oscillating current (Kilo volts®Mega Volts). One exciter coil is “on” while the other is “off”. When the powered coil is open the collapsing magnetic field potentates the electron flux emanating from the exciter coils. The alternating electron flux from the high frequency high voltage exciter coils is pushed across the magnetic flux lines emanating from the static magnetic bodies and in the presence of the collector coils the electrons flow according to the left hand rule along the route of least resistance i.e. the conductor coils. It requires very little “energy” to push the free electrons across the magnetic lines of flux due to the high frequency and high voltage but low amperage of the exciter coils. At the resonance point of the system no current is flowing in the exciter coils, only high frequency, high voltage oscillation, which generates magnetic flux, which repels and or pushes the free electrons. In a three phase system there are three power boards which are operated such that the exciter coil pairs are phased such that the “making and breaking” circuits either through slip rings or vacuum switches are 120° out of phase and they are tuned for maximum power output at but not limited to 30-60 cycles/second, therefore after the output is transformed and filtered 3 phase 60 cycle current is generated.

A further method and apparatus of the present invention relates to the conversion and/or manipulation of energy from electrons “at large” (free electrons) to electrical and ultimately mechanical energy by exciting and harnessing the free electrons. More particularly the present invention relates to a series of large elliptical conductor coils which were wound and laid into a laminated steel stator board which is separated from the coils by DMD 5-5-5 slot insulation. The back of each slot is attached to a support means. As current is drawn from the circuit the magnetic poles in the iron increase in intensity. In close proximity to and facing the stator board is an armature board composed of laminated steel and wound with shielded exciter coils which serve the same function as the armature on a classic generator and are wound with shielded copper magnet wire wound within sets of coils. The current (flowing electrons) is generated as noted above by passing high frequency, high voltage, high amperage current as a carrier current though the coils of the armature board and subsequently low voltage, high amperage DC currents fed through the low resistance circuit created by the carrier currents. Therefore large amount of current (flowing electrons) may be pushed through the circuit utilizing small amounts of EMF thereby creating a large magneto motive force in both the armature board and the stator board. Very little “energy” or power is required to push the free electrons through the exciter due to the high frequency and high voltage of the carrier waves which cause the electrons to be driven peripherally to hover along the outer surface of the conductor. A low voltage high amperage DC current is fed into the circuit and rides along the outer surface of the magnet wire. Due to the decreased resistance very little energy is required to push the electrons through the circuit. The magnetic field created by flowing electrons is translated into magneto motive force (MMF) in the laminated steel in which the coils are contained. The MMF is not influenced by the resistance in the circuit, the shielding of the stator coils or lack thereof. The energy output of the MMF is as powerful as if it had been generated by a high resistance circuit. Therefore the system requires less energy input than the energy output. Power is collected from both the stator board and the armature board. The stator board generates power from the transmitted MMF off the armature board during the phase of the cycle when the current is being fed though the coils of the armature board. The current feed to the exciter or armature board creates an MMF in the iron of the board. During the one half of the cycle when the current feed to the armature board is off the MMF in the iron collapses and pushes current from the armature board, which is collected through a series of slip rings, and is fed back to the battery power supply to recharge the battery pack. The high frequency current in the exciter board must be shielded from the stator or collector board by aluminum mesh wire, which encases the exciter board and shielding of the coil wire. The aluminum mesh will allow the magnetic flux to pass from the exciter iron to the stator in the same fashion as a standard generator but will not allow passage of the high frequency currents.

2. General Background of the Invention

The earth upon which we live has existed for a number of years. It is safe to say that man has resided upon the earth for thousands to millions of years. Only over the past four hundred years or so has man begun to destroy the very earth upon which he lives and depends, for all of his life support. Man is using large amounts of the exhaustible energy from the earth, largely in the form of fossil fuels. We are rapidly depleting our energy resources, polluting the environment and increasing global warming. We need an alternative energy supply. In addition to the environmental impact, the economic impact is spinning out of control.

The need for power generation units, which do not destroy the energy equilibrium of the earth for an infinite period of time, is obvious. If one looks at all the renewable sources available each one has significant problems of availability, reliability and expense if approached with our currently accepted knowledge base. These resources are solar, wind, hydroelectric, electrostatic, temperature, differential and gravity. If one could use all of these sources in an economically sound fashion, the cost of energy would drop and the availability would increase. These changes would save the ecosystem of the planet.

Here the current invention reveals a method of capturing free electrons or “electrons at large” and through the driving force of high frequency, high voltage AC current which create magnetic flux density within the conductor and thereby drives the electrons to the surface of the wire and allows DC currents to push electrons though a closed circuit, with little resistance whereby the electron flow may be converted to other forms of energy such as mechanical, thermal or photic. This system will produce vast amounts of electrical energy with low energy input by the use of the high frequency, high voltage along with low voltage high amperage DC current charging of inductive coils which alternate between charging and collapsing currents. These coils are contained in slots of laminated steel. The current flow through this laminated steel creates powerful alternating magnetic poles which creates a powerful MMF. This armature board faces the open slots of a stator board separated by an aluminum screen, such that the pulsating magnetic field excites the free electrons surrounding the stator coil and pushes them into the stator coils which are contained in the facing steel laminated slots. The magnetic field of the stator creates MMF, pushes the electrons along the collector coils in compliance with the “left hand rule”. The magnetized laminated steel creates the EMF. The current is pulsed DC at 20-60 cps. This 60 Hz is created by the frequency of the exciter coil, (an aluminum wire mesh or screen provides a method of containing the high frequency).

### BRIEF SUMMARY OF THE INVENTION

In the previous provisional applications, there was revealed a method of enhancing gravitational force through a mechanical advantage and converting the energy though a “special generator to electrical energy and taking a portion of the electrical energy and through additional mechanical advantage lifting the mass back to a position to allow the use of the force in a repetitive fashion” Application No. 2 describes in detail a second embodiment which may be used alone or in combination with #1 by the use of the principles described in provisional #3 filed Jul. 4, 2001.

The present invention (a portion of which was initially revealed in the previous provisional application Nos. 4 and No. 5) describes a totally new and more efficient concept in power generation in which a small expenditure of electrical energy may be magnified many times by taking advantage of high frequency high voltage currents which are magnified by charging and discharging inductive exciter coils which push waves of free electrons from the high frequency electron brush into magnetic lines of flux which push the free electrons into or onto conductor coils. Therefore, it is a principal object of the present invention to provide the method and apparatus of a previously undescribed method of generating electricity. The power is generated by charging the exciter coils with high frequency and moderately high voltage. Minimal current is required. The frequency is tuned to resonance of the system. The electrostatic brush which is created pushes free electrons (“electrons at large”) into the surrounding static magnetic field. This exciter board magnifies the RF signal from 400→750 watts to greater than 100,000 watts of RF power. This power is fed into the coils of an exciter armature board which are contained in laminated steel slots. The exciter coils are wound and placed in laminated steel in insulated slots to form a fixed armature. The coils are charged with high voltage and high frequency but low amperage oscillating current are fed by high amperage low voltage DC as well as high frequency high voltage low amperage AC currents. When the circuit is closed the high electron flow magnetizes the iron thereby inducing a high density magnetic flux in the iron, just as a classic generator. The fixed armature faces a wound stator which is also in laminated steel and in close proximity, but shielded from the high frequency A/C by an aluminum screen which allows the magnetic field of the armature to drive the electrons into the magnetic field of the stator the electrons are pushed along the conductor wires of the coils in the stator by the magnetic field in the iron in compliance with the “left hand rule”. Electrons build electrical pressure in and around the copper wire conductor coils. When a load is applied or the circuit is closed electrons will move along the wire from negative to positive. These electrons pass along the conductor and we have current electricity. When the optimum frequency of oscillation is reached by the frequency generator along with the optimum voltage and the optimum frequency of the switching cycles of the exciter coils is reached, the entire system may be powered by a battery pack, which may be recharged from the generator or other external power source. These generators may function as stand alone power sources or may be placed at power stations, sub-stations etc. to greatly magnify the available electric power

### BRIEF DESCRIPTION OF THE DRAWINGS

For a further understanding of the nature objects and advantages of the present invention reference should be made to the following detailed description, read in conjunction with the following drawings, wherein like reference numerals denote like elements and wherein:

FIG. 1 is a representation of a 3′×4′ polyphonal fiber board in which is embedded multiple end to end 3000 gauss magnets 6″×1″×¼″ with the 6″×1″ dimension being the face, with face changed North (“N”) poles facing outward in the superior portion and south (“S”) poles facing outward in the inferior rows.

FIG. 2 is a representation of a coil of magnet wire wound with 3 wires and 100 turns of #22 exciter wires and #19 collector wire. The coil is embedded into the board in grooves cut by a router and filled with epoxy. One wire in the coil is a conductor coil and the other two are exciter wires.

FIG. 3 is a representation of the complete alternating current cycle of FIG. 4.

FIG. 4 is a representation of the alternating direction of current flow in the circuit of the invention, which is controlled, by the alternative direction of feed of the high frequency exciter fields “C” and “D”.

FIG. 5 is a representation of the complete AC cycle of the conductor coil which is generated by alternating activation of the high frequency high voltage “C” coil and the “D” coil.

FIG. 6 is a representation of the augmentation of the AC cycle of the induction coil by the alternating collapse of the high frequency high voltage of the “C” coil and the “D” coil.

FIG. 7 is a representation of the complete circuit of a single phase of the invention. Three replications made up in a wye connected or delta connected hook up (modified) with the exciter circuits of the three (3) phases 120° out of phase with each other will create a three phase power with superimposed high frequency current.

FIG. 8 is a representation of the three-phase waveform of the invention.

FIG. 9 is a representation of the energy source high voltage high frequency high amperage exciter circuit along with the static armature and stator of the invention.

### DETAILED DESCRIPTION OF THE PREFERRED EMBODIMENTS

Reference will now be made in detail to the presently preferred embodiments of the invention, examples of which are illustrated in the accompanying drawings. Throughout the drawings, like reference characters are used to designate like elements.

Demonstration of the Effect of Frequency and Voltage of the Exciter Currents, Frequency of the Alternating Exciter Circuits upon Power Output of the Present Invention.

The power output of this invention is dependant upon proper tuning of the system. The parameters, which must be tuned, are exciter circuit frequency, frequency of the alternating exciter circuit direction and voltage of the exciter current.

| 1) Exciter current frequency. | | |
|---|---|---|
| The exciter current frequency is the most important | | |
| variable that has been reorganized this far | | |
| Exciter frequency | 7.1 | MHZ |
| Transmitter input into system | 50 | watts |
| Power output from system (100 volts 7.6 amps) | 750 | watts |
| Frequency of alternating exciter circuits | 60 | cps |
| Exciter frequency | 14 | MHZ |
| Transmitter input to system | 60 | watts |
| Power Output from system (300 volts 10 amps) | 3000 | watts |
| Frequency of alternating exciter circuits | 60 | cps |
| 2) Frequency of alternating exciter | | |
| circuit directional change. | | |
| Exciter Frequency | 14 | MHZ |
| Exciter circuit power input | 80 | watts |

Exciter circuit directional change

| Frequency | Power output |
|---|---|
| 1.0 cps | 500 volts × 15 amps = 7500 watts |
| 20.0 cps | 550 volts × 35 amps = 19,250 watts |
| 40.0 cps | 750 volts × 40 amps = 30,000 watts |
| 60.0 cps | 300 volts × 10 amps = 3,000 watts |

| | | |
|---|---|---|
| 3) Power of Exciter Cells | | |
| Exciter frequency | 14.0 | MHZ |
| Exciter directional change frequency | 20.0 | cps |

| Power input to Exciter Circuit | Power output |
|---|---|
| 60 watts | 15,552 watts |
| 160 watts | 35,952 watts |
| 250 watts | 63,525 watts |
| 500 watts | 100,433 watts |
| 750 watts | 115,500 watts |

The best excitation frequency based on current data is ±14.0 MHZ, the best rate of directional change of the exciter circuit is ±20.0 cps and the maximum effective voltage has not yet been reached.

The use of this technology is not limited to size or application.

The present embodiment of the energy cell is represented in the following figures as shown in FIG. 9, radio frequency transmitter 1 (as described above) generates a RF current (1.0→20.0 MHz) which is transmitted via conductor 2 and 3 to amplifier 4 where it is amplified and transmitted through conductors 5 and 6 to RF power magnification board 24. The common conductor 5 is connected to a “center tap” connection from the end of RF1 coil and the beginning of RF2 coil in the board 24 (board 24 is fully described in provisional patent filed Jan. 24, 2002). and in the present description. The power lead or positive conductor 6 feeds high frequency current to slip rings 7 and 8. This pair of slip rings allows alternate powering of the RF1 and RF2 coils in the power board 24. The circuit 6 is closed to RF1 while it is open to RF2. The cycling occurs at 20-60 cps. The current flow in slip ring 7 is fed to brush 19 which runs on small slip ring 17 which is attached to active side of slip ring 7 through conductor 18. Section 16 of slip ring 7 is closed to slip ring 17 and section 15 is open. Brush 20 is in contact with slip ring 7 and is attached to conductor 22 which is wired to the (+) side of RF2. The current flow in slip ring 8 is fed to brush 11 which is in contact with small slip ring 14 which is attached to active side of slip ring 8 through conductor 13. Section 9 of slip ring 8 is closed to slip ring 14 and section 10 is open. Brush 12 is in contact with slip ring 8 and is attached to conductor 21 which is wired to the (+) side of RF1. These high frequency circuits alternate opening and closing 20-60 times per second these high frequency currents excite surrounding free electrons and drive into the static magnetic fields which underlay the coils of this board. The superior potion of the board contains (+) magnetic flux field generated by embedded static magnets and the inferior portion of the board contains (−) magnetic flux field. As the free electrons are excited the static magnetic fields push them along conductors 25 and 26. This board will magnify a 750 watt input signal to 115,000 watt output signal. The output signal is modulated through slip rings 27 and 35 such that the signal is fed to board A approximately 50% of the time and is cycled 20-60 cps. Conductor 26 is attached to brush 31 which contacts slip ring 30 which is connected to segment 28 of slip ring 27 through conductor 32. Segment 29 of slip ring 27 is an open segment. Current is fed off of segment 28 through brush 33 through conductor 34 and to conductor 42 onto lead 81 of armature board A. Conductor 25 is attached to brush 39 which contacts slip ring 38 which is connected to segment 36 of slip ring 35 through conductor 40. Segment 37 of slip ring 35 is an open segment. Conductor 25 which is the common lead from board 24 is connected to brush 39 which contacts slip ring 38 which is connected through conductor 40 to segment 36 of slip ring 35. This common lead is made up to conductor 43 through brush 33a and conductor 41. It then is connected to lead 82 of armature board A. Board A is powered by DC current which is pushed through the conductor coils over the high frequency high voltage carrier wave. The high frequency carrier wave greatly reduces the resistance to current flow through board A. The DC feed to board A is supplied by battery pack 44 through power supply 45. Positive lead 47 is connected to brush 59 which is in contact with continuous slip ring 84 which is connected to segment 56 of slip ring 55 through conductor 58. The current is taken off of segment 56 by brush 57 onto conductor 64 which connects to conductor 42 and in turn makes up with lead 81 of board A. Negative lead 46 from power supply 45 contacts brush 48 which is in contact with continuous slip ring 86. Slip ring 86 contacts segment 56a of slip ring 54 through conductor 49. Brush 50 contacts segment 56a and makeup to conductor 43 through conductor 65. Conductor 43 makes up with negative lead 82 of armature board A (75).

During operation, slip rings 27 and 35 along with 54 and 55 are placed on a common shaft and are synchronized such that the high voltage high frequency current from board 24 is fed onto the coils of board A (75) at the same time as the DC current. Approximately 40% of the rings circumference are powered and the RF leads the DC by about 5° on the timing cycle. The slip rings cycle 20-60 cps. Board A (75) is wound in 20 inch laminated steel 80 with 2 inch tooth width and 1.0 inch back iron. Coils 76, 77, 78 and 79 are wound with eight No. 10 plus two No. 4 copper magnet wire and 30 turns or equivalent formula of shielded wire. When board A (75) is powered with 75 amps DC and 30 volts with the current wiring in Board B (66) [2 No. 23 copper magnet wires and 2,000 turns with the same iron formula, size and number of coils as Board A (75)] the unit is putting out through conductors 72 and 73 power to light board 74. The power output is measured at 75 amps and 30 volts (22 50 watts).

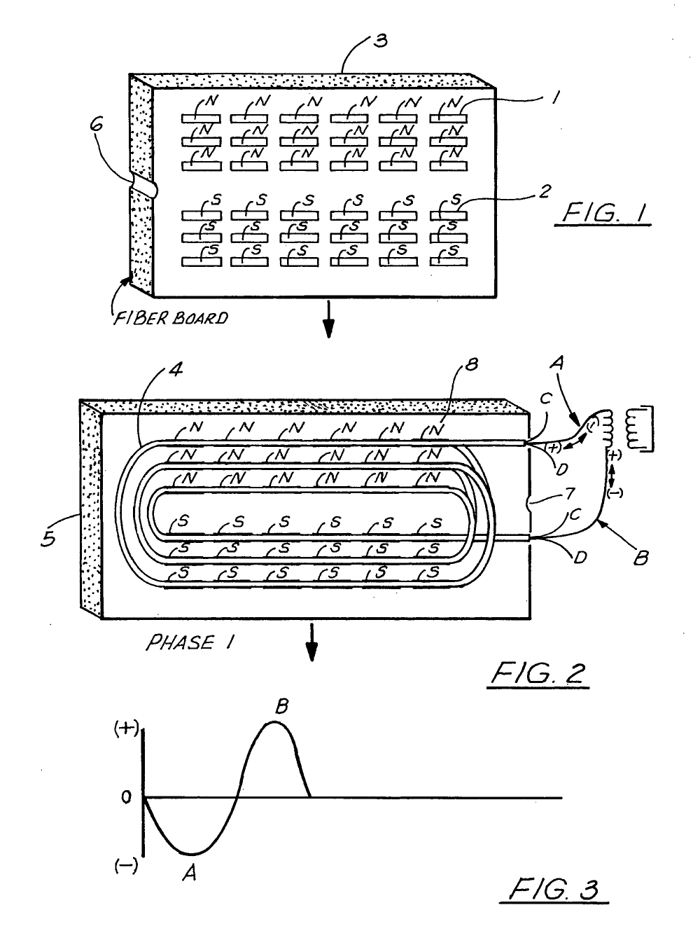

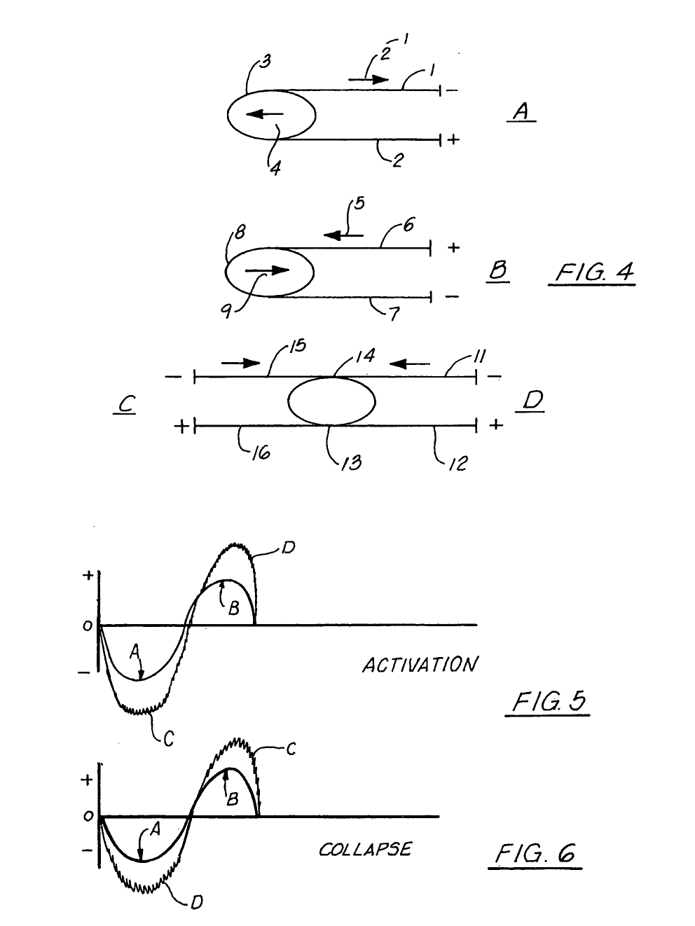

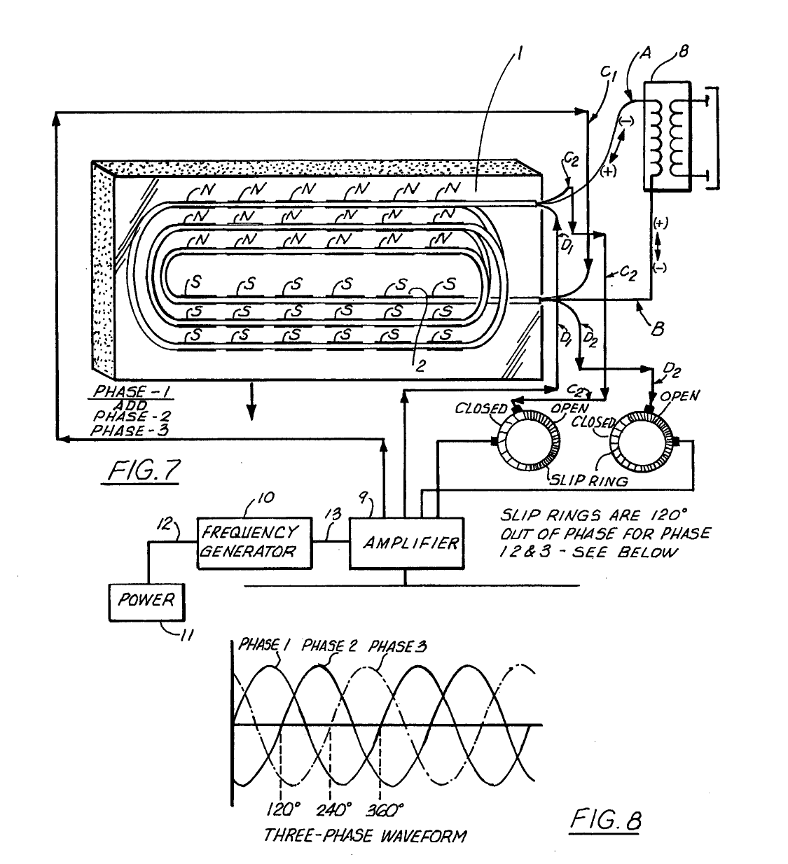

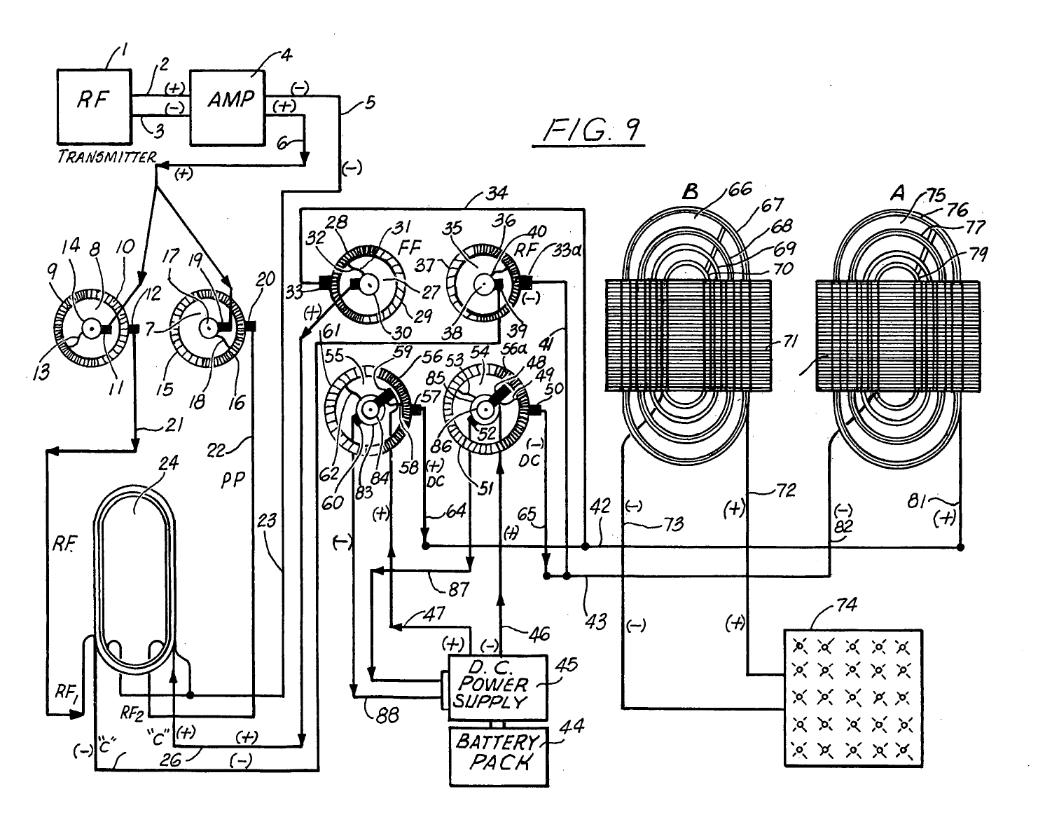

Board B (66) serves as a stator when board A (75) is placed with the face of each board being brought together and separated by a grounded mesh screen to filter out the high frequency current coming from board A. The induced current being generated in board B (66) is likely only at 5-10% efficiency due to the winding formula. The more correct formula is 3 No. 6 wires or 6 No. 9 wires and 85 turns in 4 coils. This winding change will increase the power output by up to ten fold. Another source of power which has not been utilized in past embodiments but is incorporated into FIG. 1, is the capture of the power generated 20-60 times per second from board A (75) due to the collapsing magneto motive force. Currently that power has been discharging to ground with dramatic arc discharge. In FIG. 1, segments 61 from slip ring 55 and 51 from slip ring 54 will pick up this power and discharge it through conductors 62 and 53 to slip rings 83 and 85 to brushes 52 and 60 through conductors 87 and 88 back to a rectifier in the power supply and back to recharge the batteries.

With these changes, a 2600 watt input will produce approximately 250 volts and 100 amps or about 25,000 watts of power.

The foregoing embodiments are presented by way of example only; the scope of the present invention is to be limited only by the following claims.

1. A system of generating high frequency electric power by exciting free electrons harnessing them and pushing them in a circuit by the use of magnetic flux and a collector coil comprising the steps of:
a) devising an electrical conductor coil, which is wound concurrent with and parallel to two exciter coils and attached to a support means;
b) attaching said support means to a second support means containing rows of strong uniformly face charged magnets;
c) fixing said two (2) support means together such that the superior portion of the coils are in close proximity to a row of north pole producing magnetic bodies and the inferior portion of the coils are in close proximity to south pole producing magnetic bodies;
d) the exciter coils emitting a high frequency electron flux in alternating opposite directions which is pushed by induced magnetic flux, and;
e) the excited electrons pushing free electrons into the static magnetic lines of flux, which pushes the free electrons though the collector coil to generate potential and current flow, which is power.

2. The system of claim 1, wherein the electrical conductor coil and co-wound exciter coil are comprised of a suitable magnet wire such as copper of variable size as dictated by the power need.

3. The system of claim 1, wherein the support means is constructed of insulator material (strong dielectric) such as polyphonal in which the coils of the invention are embedded by router channeling the board.

4. The system of claim 1, wherein the second support means contains powerful elongated magnetic bodies which are embedded in the support means in parallel rows in proper proximity to the co-wound conductor and exciter coils.

5. The system of claim 1, wherein the magnetic bodies of the invention are constructed into elongated magnetic bodies of any quality magnetic material such as iron-boron or neodymium.

6. The system of claim 1, wherein the magnetic bodies of the invention may be arranged in any configuration in which a progressive flow of electrons in the coils is propagated.

7. The system of claim 1, in which the co-wound exciter coils are arranged such that the current flow may be fed in opposite directions to each other when the circuits are closed.

8. The system of claim 1, wherein the alternating directional feed into the exciter coils may be accomplished by any apparatus which will quickly break and make up the circuit, such as slip rings, or dipole vacuum switches which maintain one exciter circuit off while the other is on.

9. The system of claim 1, in which the power source may be AC or DC either from a generator of a battery.

10. The system of claim 1, in which the high frequency source may be a radio transmitter which drives an amplifier or modified Tesla Coil or other frequency generator.

11. The system of claim 1, in which the collector coil which collects high frequency, high voltage and high amperage current feeds any apparatus for the provision of high frequency and high density electrons.

12. The system of claim 1, in which a source of high frequency, high voltage and very low amperage current is fed into two alternating direction exciter coils which serves to oscillate and push surrounding electrons thereby generating a high frequency induced magnetic flux.

13. The system of claim 1, wherein the oscillating electrons from the exciter coils oscillate and the induced magnetic flux push free electron into the static magnetic flux line of the device which are in close proximity to the collector coils and push the electrons down the collector in a direction compatible with the left hand rule and build an significant electromotive force.

14. The system of claim 1, wherein the exciter coils are fed high frequency, high voltage current in alternating opposite directions which produces energy of excitation during the activating and collapsing phase.

15. The system of claim 1, wherein the exciter circuits require very low energy input in relation to output of the energy cell when operated at the point of resonance.

16. The system of claim 1, wherein the exciter circuits are phased by low energy requiring switching methods which may be cycled to be compatible with the entire system.

17. The system of claim 1, wherein the entire system must be tuned to attain the proper resonance, therefore, the turning process comprises the steps of:
a. tuning the proper frequency of the frequency generator;
b. tuning the proper voltage and amperage of the amplifier; and
c. tuning the proper frequency of cycling the alternating directional feed of the exciter coils.

18. The system of claim 1, wherein the generated current may be fed into a second stage power cell to alter the resistance in the internal conductor circuits.

19. An apparatus for generating high electric power by exciting free electrons harnessing them and pushing them in a circuit by the use of magnetic flux and a collector coil, the apparatus comprising:
a) an electrical conductor coil, wound concurrent with and parallel to a multiple exciter-coils and attached to a support means;
b) a second support means containing rows of uniformly faced charged magnets;
c) said two support means together so that the superior portion of the coils are in close proximity to a row of north pole producing magnetic bodies and the inferior portion of the coils are in close proximity to south pole producing magnetic bodies;
d) a high frequency electron flux in alternating opposite directions pushed by induced magnetic flux, which is emitted by said exciter coils; and
e) means for pushing free electrons into the static magnetic lines of flux, which pushes the free electrons though the collector coil to generate potential and current flow, defining power.

20. A system of utilizing a high voltage, high frequency exciter current as a carrier wave which decreases resistance for high current flow DC through shielded conductor wires to generate a high magnitude magneto motive force which when cycled will serve as a high efficiency electron pump for the magnification of power, comprising the following steps:
a) winding a armature of laminated steel with shielded copper, aluminum or other suitable conductor;
b) feeding a high frequency high voltage, high amperage carrier wave onto the shielded conductor coils;
c) activating the shielded conductor coils by moderate voltage, high amperage DC current which travels over the carrier wave on the shielded conductor coils;
d) the high amperage DC current flows through the coils with low resistance such as a super conductor thereby generating a strong magneto motive force in the iron; and
e) as the system is cycled, the activating and collapsing of the magneto motive force in the laminated iron pump free electrons in high magnitude onto the shielded conductor wires and is discharged to a load.

21. The system in claim 20, wherein a second board facing and in contact with an armature board comprises a laminated steel stator board wound with the proper formula of conductor material to generate additional electric power, which is activated and driven by the magneto motive force of the armature board.
